(19) United States
(12) Patent Application Publication
(10) Pub. No.: US 2025/0321442 A1
(43) Pub. Date: Oct. 16, 2025

(54) DEVICES AND METHODS FOR LOW VOLTAGE OPTICAL MODULATION

(71) Applicant: The Trustees of the Stevens Institute of Technology, Hoboken, NJ (US)

(72) Inventors: Yuping Huang, Norwood, NJ (US); Yong Meng Sua, Fort Lee, NJ (US); Mingwei Jin, Jersey City, NJ (US); Jiayang Chen, Jersey City, NJ (US)

(73) Assignee: The Trustees of the Stevens Institute of Technology, Hoboken, NJ (US)

(21) Appl. No.: 19/076,536

(22) Filed: Mar. 11, 2025

Related U.S. Application Data
(62) Division of application No. 17/923,554, filed on Nov. 4, 2022, now Pat. No. 12,292,626.
(60) Provisional application No. 63/021,012, filed on May 6, 2020.

(51) Int. Cl. G02F 1/03; B82Y 20/00; G02B 27/28; G02F 1/035; G02F 1/225; G02F 1/31

(52) U.S. Cl. CPC G02F 1/0316; G02B 27/286; G02F 1/0305; G02F 1/035; G02F 1/2257; B82Y 20/00; G02B 2207/101; G02F 1/31; G02F 2203/15

(57) ABSTRACT

An electro-optic modulation structure 110, a method for fabrication of the electro-optic modulation structure, and a method of optical modulation derived from an electro-optic modulation structure with low voltage of operation are disclosed. The low voltage operation of the electro-optic modulator is realized by designed electro-optic modulation structures that include the light confining waveguide 114, overclad layer 120 and modulating electrode structure 116 for applying modulation voltages that are directed towards a low voltage operation of the electro-optic modulation 110 device upon consideration of optimal optical loss. (FIG. 3).

### CROSS-REFERENCE TO RELATED APPLICATION

This application claims priority to U.S. Provisional Patent Application Ser. No. 63/021,012 filed May 6, 2020, the entire disclosure of which is incorporated herein by reference.

### FIELD OF THE INVENTION OR TECHNICAL FIELD

The present invention relates to electro-optic systems.

### BACKGROUND OF THE INVENTION

Electro-optic devices are crucial in transforming radio frequency (RF) and electronic signals into the optical domain and vice versa, serving as the key components in optical interconnections in telecommunication systems and data centers, RF photonics, 5G infrastructure, beam steering, and quantum photonics. Electro-optic devices with low operation voltage at small scale, including, but not limited to, electro-optic phase shifters and modulators are important for the integration of electro-optic devices with, for example, lithium niobate thin film on various monolithic and heterogeneous integrated photonics platforms. In particular, high voltage and energy efficient electro-optic devices are essential for addressing the future bandwidth demands of modern communication systems utilizing advanced modulation formats and coherent detection schemes that encode data onto both the amplitude and phase of optical signals. The realization of low voltage electro-optic devices can significantly reduce the energy consumption, physical footprint and complexity of electro-optic circuits that include the electro-optic devices and corresponding electronic driving circuits.

### SUMMARY OF THE INVENTION

A low voltage-drive Electro-optic modulator (EOM) on monolithic Lithium Niobate thin film is disclosed. The light is modulated in phase by electronic fields through electro-optical effects, or modulated in amplitude by the interference effect due to phase differences created by the electric field applied onto a modulation arm in an interferometer setting. The low modulation voltage and short footprint of the invented EOM are enabled by the ultra-efficient electro-optic phase shifter in the modulation arm. The phase shifter is surrounded by the metal layer to enhance the electric field density and optimize the overlap between the electric and optical field in the waveguide.

The present invention may be used for improving the energy efficiency of various electro-optical-based devices and systems, such as those used in telecommunication and data centers supporting ever increasing network traffic, cloud computing and storage. The invention could be used for energy-efficient coherent modulators for high-speed communication networks with complex, nested Mach-Zehnder modulators made using photonic integrated circuits on lithium niobate. By offering electro-optic phase modulation in a resonator, the present invention enables electro-optic frequency comb generation as a tool for optical communication, precision metrology, timing and spectroscopy. The present invention can be used to detect radio waves or microwaves with high sensitivity. By guiding the radio waves or microwaves to an electro-optic activated interferometer with coherent optical signal inputs, a small phase shift caused by the radio waves or microwaves can lead to the optical intensity change in the interferometer, thus realizing optical reading of the radio waves and/or microwaves. Additionally, the present invention could be used for optical routing and switch operation for optical interconnections in data centers or cloud storage facilities.

The present invention reduces the half-wave voltage, or the voltage required to induce a phase change of π for the light going through a waveguide, thus significantly reducing the energy required to operate the devices and systems.

The present invention presents a design with optimized placement of the electrodes, where the generated electric field density is much higher while improving the overlap between the electric and optical fields in the waveguide. Specifically, novel electrode design and placement allows for controlled generation of high-density electric fields in the desirable waveguide region.

The present invention implements a novel design of the electrodes which is advantageous in providing key fundamental improvements in electric field density and electric-optical field overlaps while maintaining low waveguide loss and small device footprint. This invention overcomes the tradeoff of modulation voltage and modulation length of a conventional electro-optics modulator. The present invention is fabricated with a standard semiconductor processing process on a monolithic lithium niobate platform, thus making it compatible with established large-scale silicon wafer processes for mass production with high yield and high reliability.

### BRIEF DESCRIPTION OF FIGURES

For a better understanding of the present invention, reference is made to the following detailed description of various exemplary embodiments considered in conjunction with the accompanying drawings, in which like structures are referred to by the like reference numerals throughout the several views, and in which: FIG. 1 shows an electro-optic modulator structure;

FIG. 2 shows a top view of a phase shifter;

FIG. 3 shows a cross-section of an ultra-efficient phase shifter in accordance with an embodiment of the present invention, the waveguide being surrounded by a gold layer with a small top gap and separated by an SiO₂ buffer layer;

FIG. 4A depicts the simulation results of electric field lines generated by a base capacitor;

FIG. 4B depicts the simulation results of electric field lines generated by a top capacitor;

FIG. 5A depicts simulation results of the horizontal component of electric field intensity of a traditional capacitor;

FIG. 5B depicts simulation results of the horizontal component of electric field intensity of the inventive capacitor;

FIG. 6 depicts the simulation result of the optical mode in Lithium Niobate ridge waveguide;

FIG. 7 shows the EOM response when applying triangle waves.

FIG. 8 shows the “racetrack resonator” based electro-optic frequency comb generator in accordance with an embodiment of the present invention;

FIG. 9 shows an optical switch structure in accordance with an embodiment of the present invention;

FIGS. 10A-10L represent respective steps of a fabrication flowchart for an EOM in accordance with an embodiment of the present invention;

FIG. 11A shows an SEM image illustrating the structure of an EOM fabricated in accordance with an embodiment of the present invention;

FIG. 11B shows an SEM image illustrating the structure of an EOM fabricated in accordance with an embodiment of the present invention;

FIG. 11C shows an SEM image illustrating a top view of beam splitter and modulation parts in accordance with an embodiment of the present invention;

FIG. 12A shows a setup for frequency response measurement in accordance with an embodiment of the present invention;

FIG. 12B is a graph illustrating S21 and S11 parameters measured on a 7.5 mm electro-optical modulator using the apparatus of FIG. 12A;

FIG. 13A is a graph of resonance measurements for a bare waveguide; and

FIG. 13B is a graph of resonance measurements for an electrode-deposited resonator fabricated in accordance with an embodiment of the present invention.

### DETAILED DESCRIPTION OF VARIOUS EMBODIMENTS

Embodiments are now discussed in more detail referring to the drawings that accompany the present application. In the accompanying drawings, like and/or corresponding elements are referred to by like reference numbers.

Various embodiments are disclosed herein; however, it is to be understood that the disclosed embodiments are merely illustrative of the disclosure that can be embodied in various forms. In addition, each of the examples given in connection with the various embodiments is intended to be illustrative, and not restrictive. Further, the figures are not necessarily to scale, and some features may be exaggerated to show details of particular components (and any size, material and similar details shown in the figures are intended to be illustrative and not restrictive). Therefore, specific structural and functional details disclosed herein are not to be interpreted as limiting, but merely as a representative basis for teaching one skilled in the art to variously employ the disclosed embodiments.

Subject matter will now be described more fully hereinafter with reference to the accompanying drawings, which form a part hereof, and which show, by way of illustration, specific example embodiments. Subject matter may, however, be embodied in a variety of different forms and, therefore, covered or described subject matter is intended to be construed as not being limited to any example embodiments set forth herein; exemplary embodiments are provided merely to be illustrative. Among other things, for example, subject matter may be embodied as methods, devices, components, or systems. The following detailed description is, therefore, not intended to be taken in a limiting sense.

Throughout the specification and/or claims, terms may have nuanced meanings suggested or implied in context beyond an explicitly stated meaning. Likewise, the phrase “in one embodiment” as used herein does not necessarily refer to the same embodiment and the phrases “in another embodiment” and “other embodiments” as used herein do not necessarily refer to a different embodiment. It is intended, for example, that covered or claimed subject matter include combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

A Mach-Zehnder interferometer (MZI) 10 with its arms 12 sandwiched by electrodes 12 is shown in FIG. 1. 1550 nm light (or light at a different wavelength) is coupled into the waveguide 14 at the input and split into two arms through a beam splitter 16, before being combined and interfered through a beam combiner 18. The central signal pad 20 and the other two ground pads 22 form a coplanar capacitor. When applying a voltage onto the signal pad 20 and grounding the other two pads 22, the electric fields with the opposite directions are generated between the two gaps. Due to electro-optic effect of the Lithium Niobate (LN) material that the waveguide is made of, the refractive index of the waveguide can be either increased or reduced in response to the electric field intensity and directions. Thereby, a controllable relative phase difference is introduced between the beams in the two arms. As a result, the light at the combiner is interfered either constructively or destructively due to the amount of the phase difference, resulting in the modulation of optical intensity.

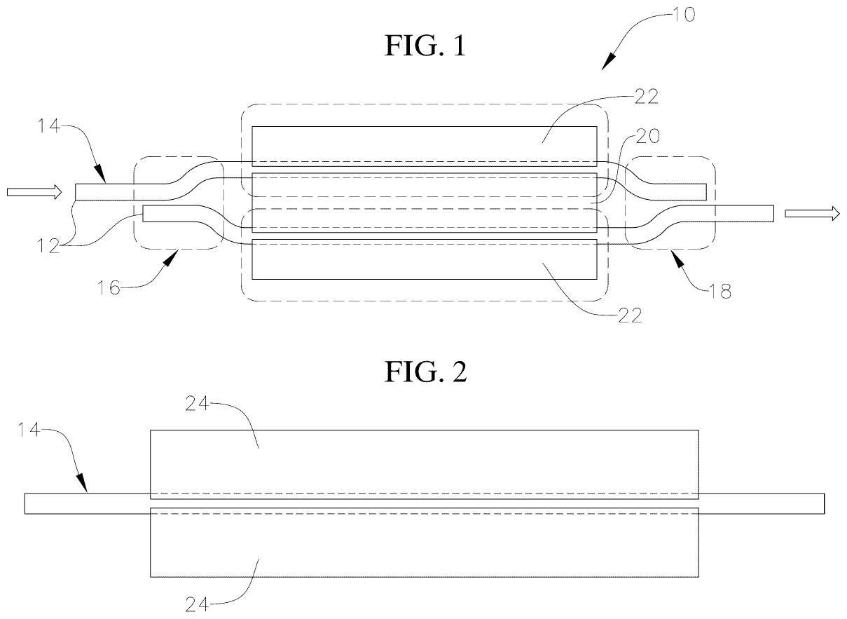

The modulation arm of an EOM is shown in FIG. 2. By itself, it can also serve as an optical phase shifter independently, with applications in telecommunications, data centers, and electro-optics. For a traditional optical phase shifter, the electrodes 24 are set on both sides of a waveguide 14 where light passes through. The waveguide 14 is etched from the commercial x-cut LN thin film bonded on Silicon substrate (not shown). Due to its strong Pockels effect (electro-optic effect), the refractive index of the waveguide will be changed when applying the horizontal electric field across the waveguide. The refractive index of the waveguide can be either increased or decreased regarding to which direction of electric field is applied. A certain distance between the electrodes 24 is set in order to minimize the optical absorption from the metal pads while ensuring strong electric field in the overlapping region with optical field. To achieve as high modulation efficiency as possible, the structure needs to be designed to use the largest component of the second order electro-optic coefficient (e.g., 30.9 pm/V). This includes to design a waveguide perpendicular to the LN crystal line and use the horizontal component (relative to the chip) of the electric field to modulate transverse electric (TE) mode of light. To reduce the π-shift voltage, which is done when applying such voltage, the phase difference between the two arms of MZI is shifted from 0 to π, one can either make modulation arms longer or increase electric field intensity. However, it is usually not practical to make the modulation arms long enough for the following reasons: First, optical absorption loss due to the metal electrode and waveguide's propagation losses are proportional to the length. Additionally, longer electrodes limit the modulation speed to below tens of GHz. Finally, a larger footprint is not compatible with large-scale integration. On the other hand, it is also not possible to narrow the gaps between the signal and ground pads to increase the electric field intensity because this will increase the optical absorption loss induced by the metal.

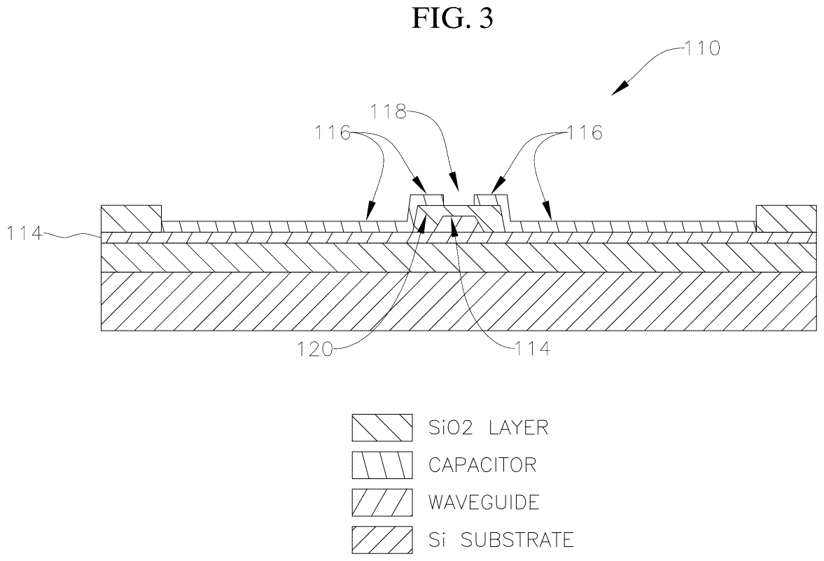

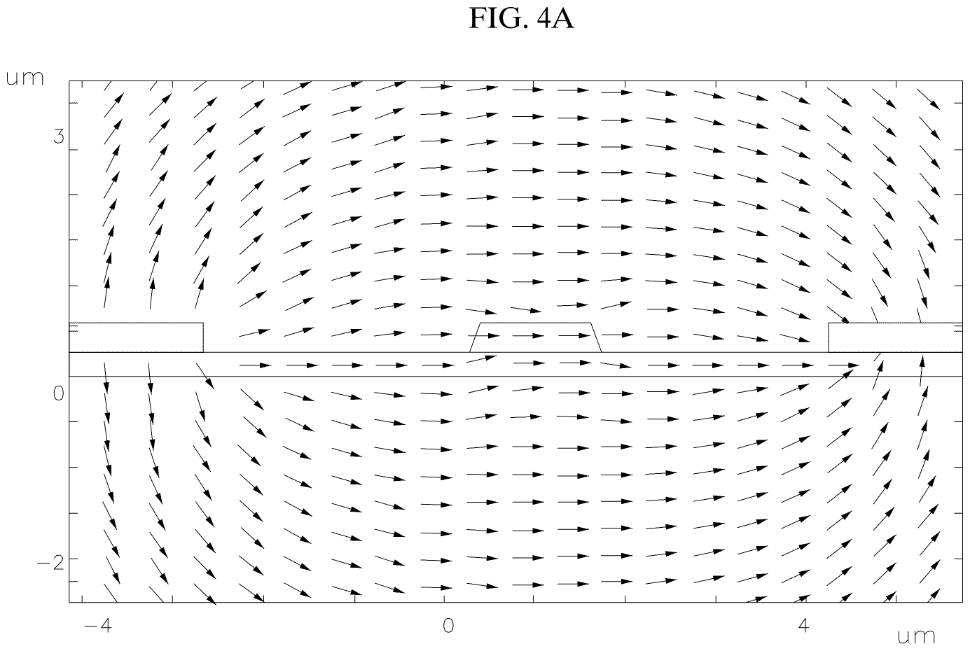

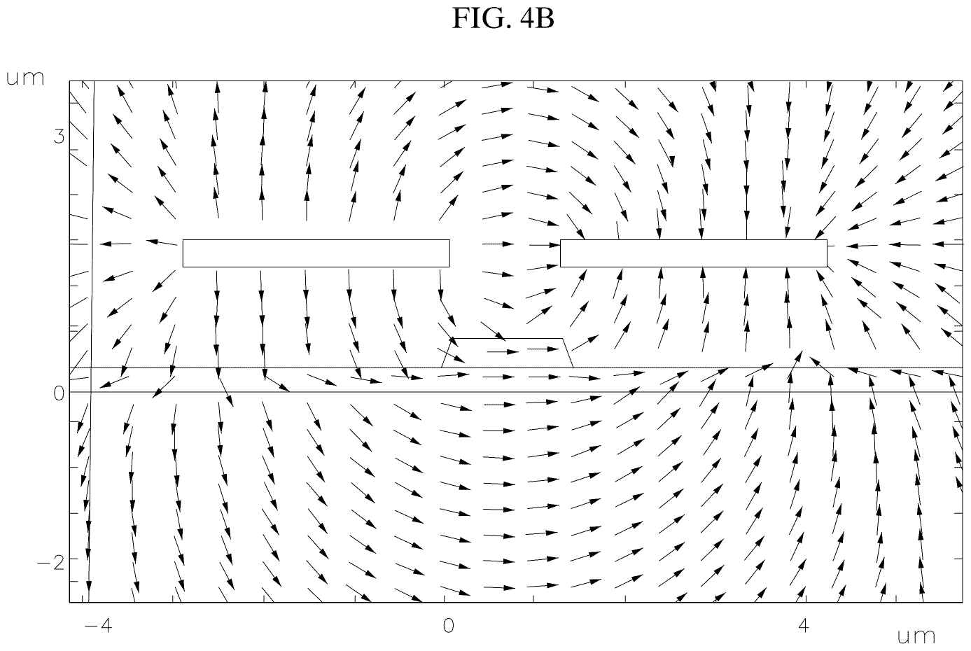

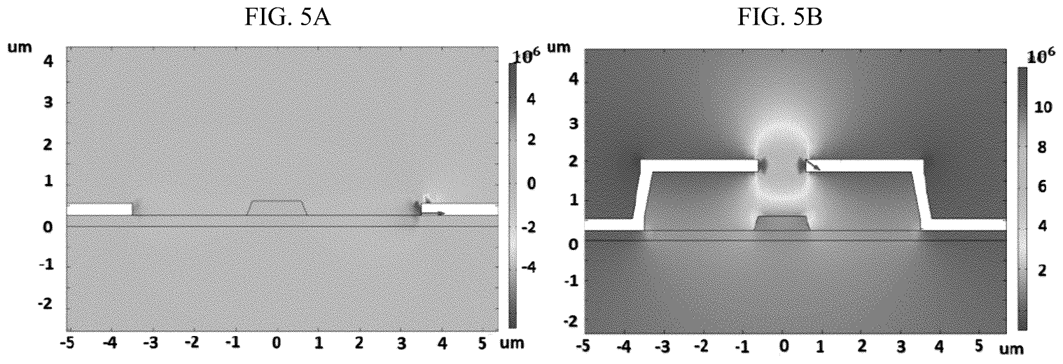

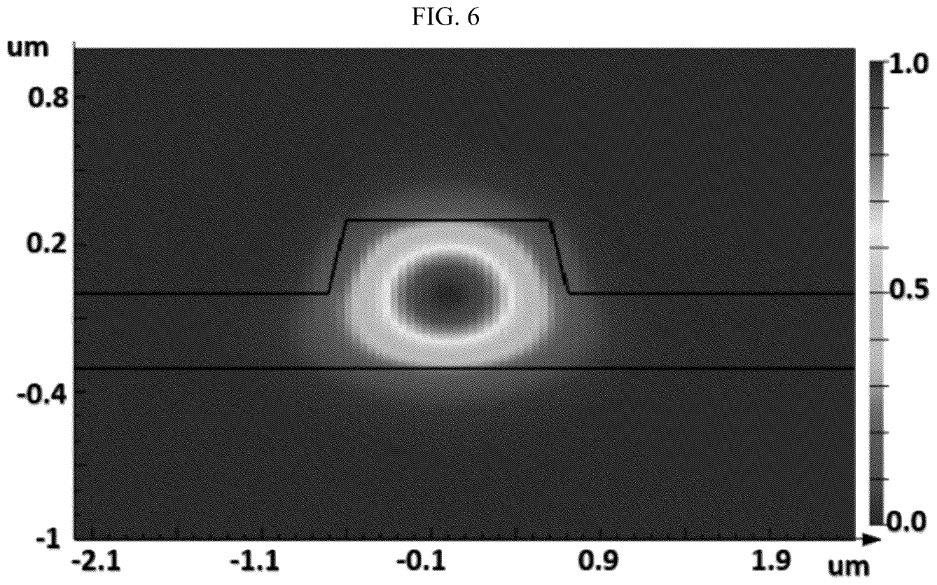

In the inventive structure 110, to increase the modulation efficiency, the metal layer (i.e., electrode) 116 is designed to surround the waveguide 114 with only a small gap 118 on the top of it in order to separate signal and ground. The metal layer 116 and waveguide 114 are separated by a SiO2 buffer layer (i.e., cladding layer) 120 to prevent absorption loss. Contrary to the traditional structure wherein the metal layer is only placed on the sides of the waveguide, the inventive design can considerably enhance the electric field intensity in the waveguide given the same voltage. FIG. 3 shows the cross section of a phase shifter (i.e., electro-optic modulator) with an electrode design in accordance with an embodiment of the present invention. The surrounding metal layers 116 form two capacitors, and both of capacitors generate horizontal components of the electric field in the LN waveguide 114. FIGS. 4A-4B show the simulated electric field lines formed by the base and top capacitors. The electric fields inside the waveguide are along the same direction, which enables coherent modulation of the optical field. From the simulation, the metal on the side wall of the waveguide as shown in FIG. 2 does not further induce the electric field. In accordance with vector addition, when putting the two capacitors together, the horizontal component of electric field intensity will be increased. FIGS. 5A-5B simulate horizontal components of electric field intensity for the traditional case and a case made in accordance with an embodiment of the present invention. In the simulation, the gap of the base capacitor is assumed as 7 um, while the top of the top capacitor is 1.2 um. The top width of the waveguide is 1.2 um, and the etching depth of it is 300 nm, leaving a remaining 300 nm LN base layer. The input voltage is assumed to be 10 volts. As a result, the simulated horizontal component of electric field intensity at the center of waveguide is about 7.1*10⁶ volt/meter and 1.6*10⁷ volt/meter respectively, showing that the electric field intensity is two-fold higher when compared to the traditional phase shifter. FIG. 6 is the simulation of optical mode distribution in the ridge waveguide.

As an example of such proposed electro-optic modulator structures, a ridge waveguide with top height of 300 nm and base height of 300 nm may be used. The width of the waveguide is 1200 nm. In some embodiments, waveguide dimensions can be varied depending on the applications. The directional coupler is used as a coupler and combiner to ensure high modulation depth. The buried SiO₂ layer is 3 um, and the cladding SiO₂ layer is 800 nm. The coplanar electrodes are placed both on the sides and the top of the waveguide, with a base gap of 7 um and top gap of 1.2 um. The lengths of the arms are set as 2 mm, 4 mm and 7.5 mm respectively. The signal is applied on the central electrode while the ground is applied on the other two electrodes so the electric fields created on the two arm waveguides are opposite, and the refractive index change and phase difference are opposite. The w-shift voltage of the proposed electro-optic modulator is measured to be as low as 2.4 volts.

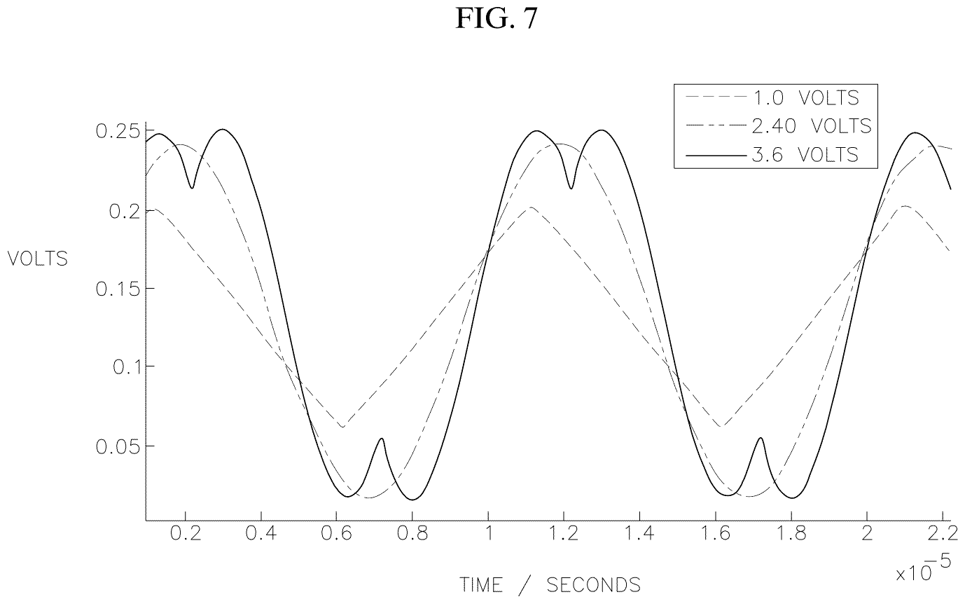

To verify the enhancement, the w-shift voltage for the modulators was measured with different top gaps. As illustrated in Table 1, the top electrode gap was varied between 1.2 um and 6 um. With 4-mm long modulation length, the w-shift voltage drops from 6.96 volts down to 3.3 volts. With 7.5 mm long modulation length and 1.2 um top gap, a lower T-shift voltage is achieved as around 2.4 volts. The different responses of EOM are shown in FIG. 7 when applying the electric triangle waves with different peak-to-peak voltages. As seen in FIG. 7, the EOM works in the linear region when applying a 1 volt triangle wave. When the voltage is increased to 2.4 volts, the EOM behaves as a sinusoidal wave as it reaches w-shift voltage. However, when a 3.6-volt wave is applied, the EOM is overdriven and the optical signal is overmodulated to show side peaks. The top capacitor gap is 1.2 um and the base capacitor gap is 7 um. The modulation length is 7.5 mm.

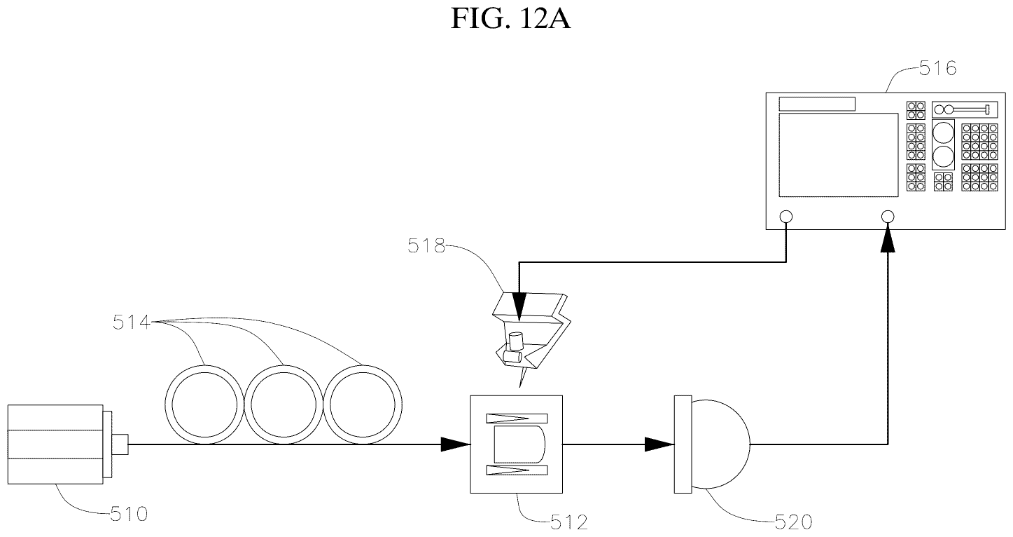

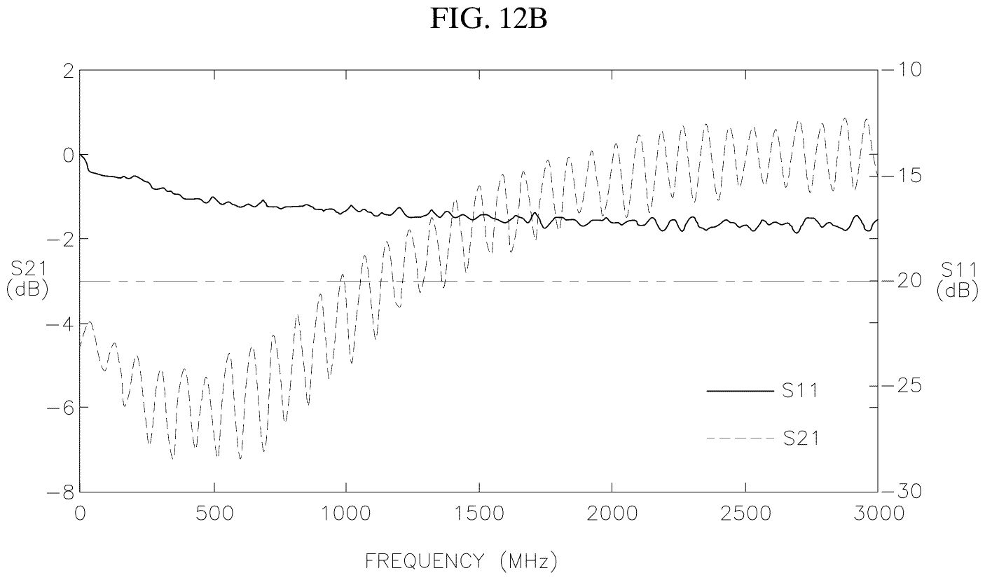

FIG. 12 shows the measurement of frequency response on the 7.5 mm long modulator. As is shown in FIG. 12A, the 1550 nm laser 510 is coupled onto a chip 512 through a polarization controller 514. An electrical signal is generated from a vector network analyzer 516 (VNA) and applied onto the chip 512 using a high-speed probe 518. The light is then coupled through a photodetector 520 to convert the optical signal to an electrical signal and then analyzed by the VNA 516. FIG. 12B plots the S21 and S11 parameters, (i.e., the electro-optical transmission and radio wave reflection). Subtracting the cable loss, the transmission loss was below 2 dB and remained nearly constant up to 3 GHz, which indicates that the 3-dB bandwidth of the device is beyond 3 GHz. On the other hand, S11 is less than −12 dB over the entire frequency range but increases as the frequency increases, signaling potential impedance mismatching at high speeds. In the future, it may be possible to carefully design the buried silicon-oxide layer thickness and the pad width and thickness for a better impedance matching case, for operations beyond 3 GHz.

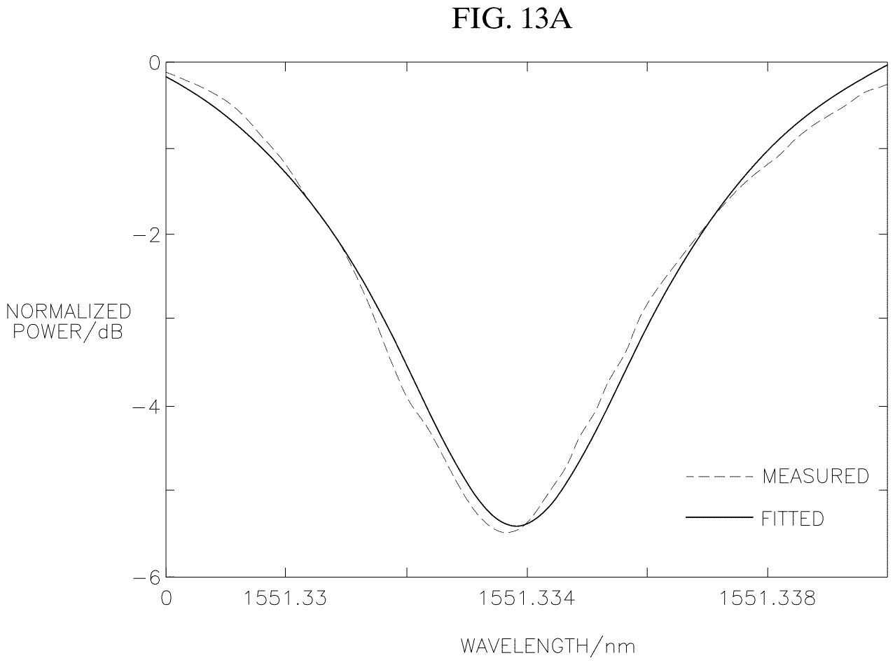

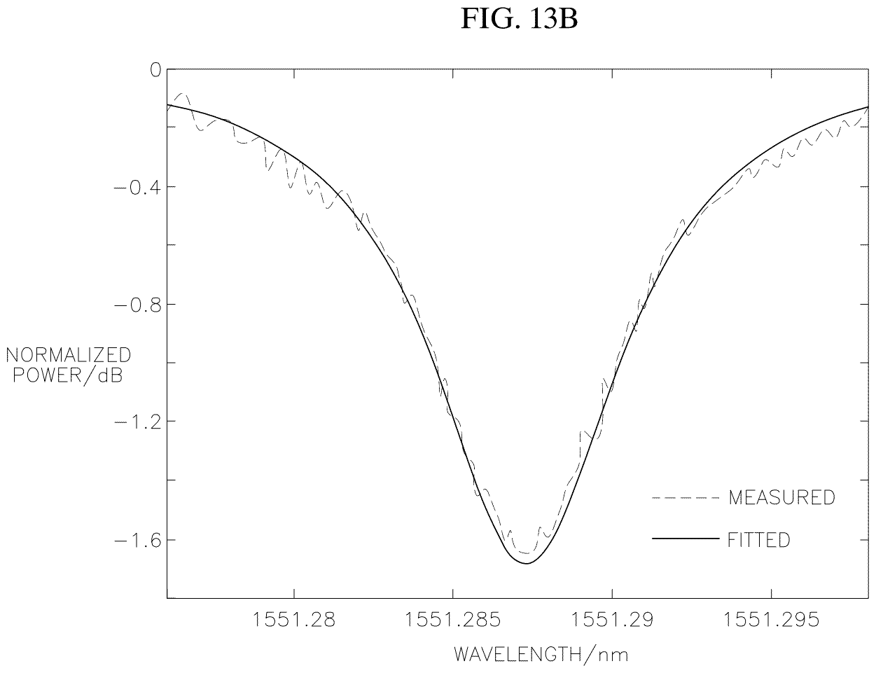

For many applications, a design consideration is verifying that the dual-capacitor structure does not induce excessive loss. To verify such, the loss was characterized using a long-arm racetrack resonator with the same fabrication recipe. FIGS. 13A and 13B show the resonance measurement of the racetrack-shape waveguide with and without the electrode. The loss caused by the electrode was determined as 0.32 dB/cm. The major loss of the current design was caused by the roughness of the waveguide, which is 1.77 dB/cm. It is feasible to further reduce the waveguide loss by smoothening the waveguide surfaces in the future.

An ultra-low π-shift voltage such as 500 millivolts (mV) or lower can be achieved with 2 cm or longer phase-shifting arms. For ultra-high-speed telecommunication, such as over 100 GHz frequency, or for applications requiring high integration, the footprint of the electro-optic modulator can be further shrunk down to mm size with 2 to 5 volts, which is a CMOS-compatible voltage.

TABLE 1
Π-shift voltages for the EOMs with different top gaps.

| Top | | |
|---|---|---|
| gap(um) | Vpi(volts) | Voltage*length(volts*cm) |
| 6 | 6.96 | 2.78 |
| 5 | 6.16 | 2.46 |
| 3.2 | 5.28 | 2.11 |
| 2.8 | 4.8 | 1.92 |
| 2.4 | 4.08 | 1.63 |
| 2 | 3.96 | 1.58 |
| 1.6 | 3.74 | 1.50 |
| 1.2 | 3.3 | 1.32 |

In some embodiments, the beam splitters and the beam combiners are implemented by the multimode interferometers and/or the Y-branches. In some embodiments, the width and thickness of the waveguides are changed to achieve the single mode for different optical wavelength or for some other applications.

In some embodiments, the thickness of LN layer will be different from 600 nm, and the etching depth can also be different from 300 nm.

In some embodiments, the dimensions of the waveguides and electrodes can be reduced to work with other optical signals with shorter wavelengths, wherein the half-wavelength voltage (π-shift voltage) can be further reduced several to ten times.

In some embodiments, the gap between electrodes will be changed to balance the absorption loss and electric field density.

In some embodiments, the thickness of the electrodes will be changed.

In some embodiments, the network of such electro-optic modulators and phase shifters can be used to implement some functions like matrix multiplication.

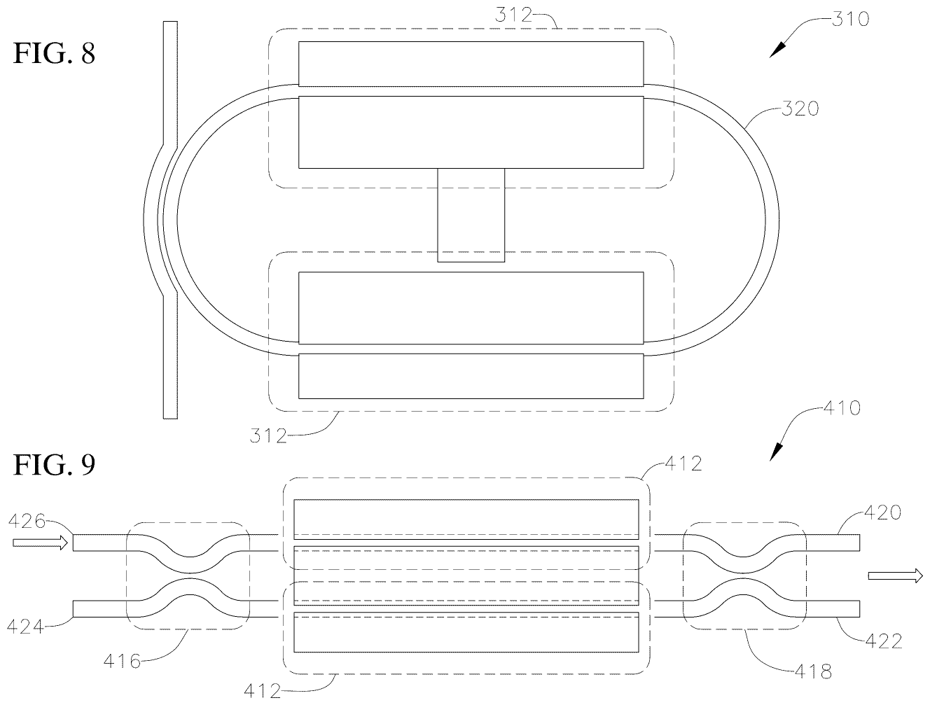

In some embodiments, the proposed ultra-efficient phase shifter can be implemented in a device 310 for generating an electro-optic frequency comb. As is shown in FIG. 8, such phase shifters 312 can be used in racetrack-shaped micro-resonator 320 structures to create comb lines. Light circulates multiple times in the racetrack resonator 320. When applying sinusoidal electrical wave onto the phase shifters, which the modulation frequency matches up to with the free spectral range of the resonator 320, the phase of the light will be modulated multiple times and new optical frequency components will be created as the comb lines. Since the frequency conversion efficiency and number of comb lines is significantly limited by the modulation index, which is defined as the ratio of applied peak voltage over w-shift voltage, reducing w-shift voltage using ultra-efficient phase shifter is an application of the present invention.

In some embodiments, the proposed ultra-efficient phase shifter can be used to implement the optical switch 410 as is shown in FIG. 9. Such an apparatus would include phase shifters 412, beamsplitter 416 and beam combiner 418. By changing the applied voltage between 0 and T-shift voltage, the output light can be switched between top output port 420 and bottom output port 422.

In some embodiments, several optical switches can be cascaded to realize a multi-port modulator, where there are more than 2 input ports and more than 2 output ports.

In some embodiments, the bottom output port 422 in FIG. 9 can be routed back to a lower input port 424, through a passage waveguide (not shown) that serves as a delay line for the signal. In some embodiments, the passage waveguide is in a spiral structure to extend the length. Using electro-optic effects to control the switch state between the cross and bar states, a signal can be looped for an integer number of times, so that it can be delayed for a discrete time. Here, the cross state means the signal from top input port 426 exits from the bottom output port 422, or bottom input port 424 exits from top output port 420. The bar state means the signal from the top input port 426 exits from the top output port 420 as shown in FIG. 9, and that the signal from the bottom input port 424 exits from the bottom output port 422. This realizes an electro-optically controlled digital delay line, which may be used for quantum communications, quantum computing, and other applications. Because of the ultra-high efficiency in the electro-optical control, many such delay lines can be integrated on the same chip and controlled only with low-voltage, fast electronic signals.

In some embodiments, the high electro-optical modulation efficiency is utilized to detect weak radio waves or microwaves. In one example, the structure in FIG. 8 is used. By applying a stable, continuous wave laser (not shown) to the microring resonator 320, a small radio wave can cause the cavity to be shifted off resonance. By detecting the transmitted optical signal, the radio wave can be detected. In another example, the structure in FIG. 9 is used. By applying a stable, continuous wave laser, a small micro wave can cause the switch 410 to change its switching status, such as changing the power splitting ratio between the two output ports 420, 422. By detecting the transmitted signal in one or both output ports 420, 422, the microwave can be detected. In both examples, the radio waves or microwaves are read out optically. This optical reading has a signal to noise limited by the shot noise of photon counting. By using a strong optical signal, the radio wave/microwave detection sensitivity can be very high, potentially to a single quantum level.

### Example Device Configuration and Fabrication

The invented electro-optic modulator is fabricated on a lithium-niobate on-insulator wafer with a 600-nm lithium-niobate thin film which is bonded on top of a 2-micron silicon oxide layer, supported on a 500-micron thick silicon substrate. The complete fabrication process is composed of three stages. The first stage is to the fabricate waveguide structure. The following stage is to fabricate trenches in order to place the gold pads. And the final stage is to fabricate electrodes.

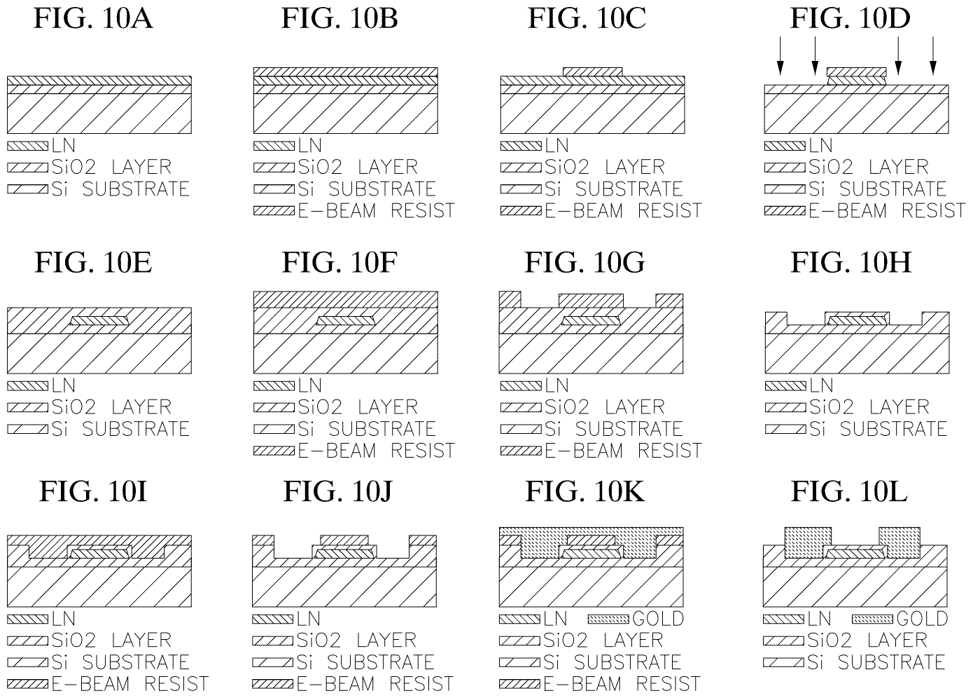

For the first stage in fabricating waveguides, after piranha cleaning (Sulfuric acid: Hydrogen peroxide=3:1) and dehydration, a 10×10 mm size sample (FIG. 10A) is immersed into an adhesion promoter (surpassing 3000) prior to spinning a 800-nm thick layer of E-beam resist (e.g., Hydrogen silsesquioxane; see FIG. 10B). The sample is pre-baked to harden the resist layer prior to E-beam lithography (EBL), which can be done with an Elionix ELS-G100 system, to perform a patterning (FIG. 10C). Following the patterning, the sample undergoes standard resist development and post-bake procedures. Then, the sample is dry etched with Argon milling process using an e-beam evaporator (e.g., AJA Orion 8E Evaporator System; see FIG. 10D) to remove the 300-nm Lithium Niobate layer and leave waveguide structures. The RCA 1 (5:1:1, deionized water, ammonium hydroxide, hydrogen peroxide) solution is used to remove the residual e-beam resist, and sputtering induces redeposited materials after the dry etching. An 800-nm silicon dioxide layer is then deposited by Oxford PECVD as over-clad (FIG. 10E).

For the second stage, the trenches are defined and etched. A 3-um thick layer of E-beam resist (PMMA 950 A11) is first spun onto the patterned film (FIG. 10F), and E-beam lithography is used to define trench structures (FIG. 10G). After developing by a solution of MIBK:IPA=1:1, the sample is dried and etched with Fluorine gas (FIG. 10H) using, for example, an Oxford Plasmalab-100 Inductively Coupled Plasma (ICP) system, which removes about 800-nm of SiO2 over-cladding layer for the trench structure. Then the residue e-beam resist is removed by acetone solution.

For the final stage, the electrodes are patterned and deposited. The procedure is the same as for the trench (See FIGS. 101 and 10J), but with the E-beam resist of 1.8-um thick layer of PMMA 495 A11 and 0.2-um thick layer of PMMA 950 A4. After developing by the solution, the sample is deposited with 15-nm thick chrome and 300-nm thick gold using an E-beam evaporator (see FIG. 10K). Then a lift-off process is finished by overnight immersion in PG removal solution for complete removal of additional metal layer (FIG. 10L). FIGS. 10A-10L show the general process of the fabrication.

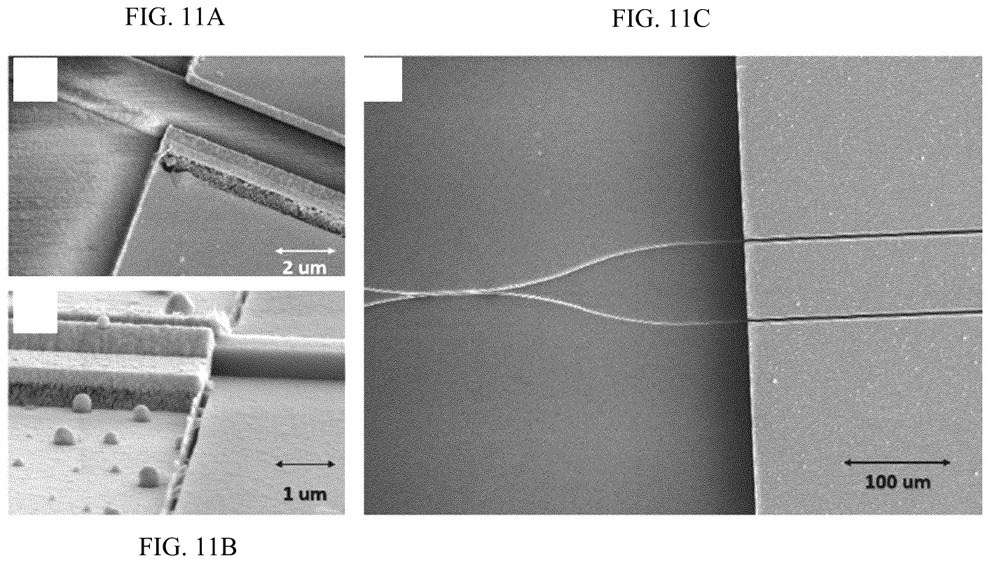

Finally, the chip is cleaved and polished for efficient light coupling. FIGS. 11A-11C shows the scanning Electron Microscope (SEM) image of the structure. FIGS. 11A and 11B show that the SiO₂-cladded waveguide is surrounded by the gold layer. FIG. 11C shows the top view of the beam splitter and the modulation part.

It will be understood that the embodiments described hereinabove are merely exemplary and that a person skilled in the art may make many variations and modifications without departing from the spirit and scope of the present invention. All such variations and modifications are intended to be included within the scope of the invention as defined in the appended claims.

1-19. (canceled)

20. An electro-optic frequency comb generator, comprising:
a microring resonator; and
an electro-optical modulator comprising
a base substrate,
a waveguide placed on said substrate, said waveguide having a raised ledge,
a pair of trenches on opposing sides of said waveguide,
a cladding layer deposited around said waveguide, and
a plurality of electrodes located on said raised ledge and in said pair of trenches.

21. The electro-optic frequency comb generator of claim 20, wherein said microring resonator has a racetrack shape.

22. A method for making an electro-optical modulator device, comprising the steps of:
fabricating a waveguide on an insulator wafer;
creating trenches around said waveguide; and
establishing electrodes around said waveguide and in said trenches.

23. The electro-optic frequency comb generator of claim 20, wherein said plurality of electrodes comprise abase capacitor on one or more side of said raised ledge and a top capacitor on a top of said raised ledge, said base and top capacitors being connected to form a dual-capacitor structure and create enhanced electromagnetic fields in said waveguide.

24. The electro-optic frequency comb generator of claim 20, wherein said waveguide has a first surface proximate said base substrate and a second surface opposite said first surface and remote from said base substrate, and
wherein said raised ledge projects from said second surface of said waveguide.

25. The electro-optic frequency comb generator of claim 24, wherein said plurality of electrodes includes:
a first electrode, including a first section in contact with said second surface of said waveguide to one side of said raised ledge thereof, a first joint at an end of said first section proximate said raised ledge of said waveguide, and a second section extending from said first joint and being offset relative to said first section such that said second section has a terminal end located a first spaced distance from said second surface of said waveguide and a second spaced distance from said raised ledge of said waveguide; and
a second electrode, including a third section in contact with said second surface of said waveguide to an opposite side of said raised ledge thereof, a second joint at an end of said third section proximate said raised ledge of said waveguide, and a fourth section extending from said second joint and being offset relative to said third section such that said fourth section has a terminal end located a third spaced distance from said second surface of said waveguide and a fourth spaced distance from said raised ledge of said waveguide, said fourth section of said second electrode being spaced from said second section of said first electrode by a fifth spaced distance, and said second joint of said second electrode being spaced from said first joint of said first electrode by a sixth spaced distance, which is different than said fifth spaced distance.

26. The electro-optic frequency comb generator of claim 25, wherein said electro-optical modulator further comprises:
a first capacitor established by said first and second joints of said first and second electrodes, respectively, upon application of an electrical potential to at least one of said first and second electrodes; and
a second capacitor established by said second and said fourth sections of said first and second electrodes, respectively, upon application of an electrical potential to at least one of said first and second electrodes.

27. The electro-optic frequency comb generator of claim 25, wherein said cladding layer has a first portion interposed between said first surface of said waveguide and said base substrate and a second portion interposed between said second surface of said waveguide and said second and fourth sections of said first and second electrodes, respectively.

28. The electro-optic frequency comb generator of claim 20, wherein said electro-optical modulator further comprises:
a beamsplitter at a first end of said modulator; and
a beam combiner at a second end of said modulator, opposite said beamsplitter.

29. The electro-optic frequency comb generator of claim 28, wherein said beamsplitter and said beam combiner are each formed from directional couplers.

30. The electro-optic frequency comb generator of claim 20, wherein said waveguide comprises lithium niobate.

31. The electro-optic frequency comb generator of claim 25, wherein said first and second electrodes comprise gold in thin films.

32. The electro-optic frequency comb generator of claim 23, wherein said base and top capacitors partially surround said cladding layer.

33. The electro-optic frequency comb generator of claim 20, wherein said cladding layer completely surrounds said waveguide.

34. The electro-optic frequency comb generator of claim 20, wherein said cladding layer comprises silicon dioxide.

35. The electro-optic frequency comb generator of claim 20, wherein said electro-optical modulator is configured to operate as a phase shifter.

36. The electro-optic frequency comb generator of claim 20, wherein said electro-optical modulator is configured to modulate the intensity of optical signals.

37. The electro-optic frequency comb generator of claim 20, wherein said cladding further comprises a buried layer interposed between said base substrate and said waveguide.

38. The electro-optic frequency comb generator of claim 20, wherein said waveguide comprises a plurality of arms, and wherein opposite electric fields are applied to two arms of said plurality of arms.

39. The electro-optic frequency comb generator of claim 28, wherein said beamsplitter and said beam combiner are implemented as multi-mode interferometers.

40. The electro-optic frequency comb generator of claim 28, wherein said beamsplitter and said beam combiner are implemented through Y-branches.

41. The electro-optic frequency comb generator of claim 25, wherein said first electrode and said second electrode are coplanar.

42. The electro-optic frequency comb generator of claim 20, wherein said electro-optical modulator forms an optical switch.

43. The method of claim 22, wherein the step of fabricating a waveguide on an insulator wafer includes:
immersing a sample into an adhesion promoter;
spinning a 800-nm thick layer of E-beam resist onto the sample;
pre-baking the sample to harden the resist layer;
performing a patterning;
performing standard resist development and post-bake procedures on the sample;
dry etching the sample to remove a lithium niobate layer and leave waveguide structures;
removing residual E-beam resist;
sputtering to induce redeposited materials; and
depositing a silicon dioxide layer on the sample as overclad.

44. The method of claim 43, further comprising the steps of
piranha cleaning the sample; and
dehydrating the sample;
wherein said piranha cleaning and dehydrating steps are performed before said immersing step.

45. The method of claim 43, wherein the step of performing a patterning is performed with E-beam lithography.

46. The method of claim 43, wherein the dry etching step is performed by an Argon milling process using an E-beam evaporator.

47. The method of claim 22, wherein the step of creating trenches around said waveguide includes:
spinning a layer of E-beam resist onto a patterned film on the sample;
defining trench structures;
drying the sample;
etching the sample; and
removing the residue E-beam resist.

48. The method of claim 47, wherein the step of defining trench structures is performed using E-beam lithography.

49. The method of claim 22, wherein the step of establishing electrodes around said waveguide and in said trenches includes:
depositing onto the sample chrome and gold; and
removing an additional metal layer from the sample.

50. The method of claim 49, wherein the depositing step is performed using an E-beam evaporator.
